(19) United States
(12) Patent Application Publication
(10) Pub. No.: US 2026/0150144 A1
(43) Pub. Date: May 28, 2026

(54) METHOD AND APPARATUS FOR PRIORITISING DATA ASSOCIATED WITH AI/ML

(71) Applicant: Samsung Electronics Co., Ltd., Suwon-si, Gyeonggi-do (KR)

(72) Inventors: Chadi KHIRALLAH, Staines (GB); Mahmoud WATFA, Staines (GB); David Gutierrez ESTEVEZ, Staines (GB)

(21) Appl. No.: 19/126,784

(22) PCT Filed: Nov. 3, 2023
(86) PCT No.: PCT/KR2023/017561

§ 371 Date: May 2, 2025

(30) Foreign Application Priority Data
Nov. 4, 2022 (GB) 2216493.3
Oct. 9, 2023 (GB) 2315488.3

(51) Int. Cl. H04W 76/18; H04W 64/00; H04W 72/21; H04W 76/27

(52) U.S. Cl. CPC H04W 76/18; H04W 64/00; H04W 72/21; H04W 76/27

(57) ABSTRACT

The disclosure relates to a 5G or 6G communication system for supporting a higher data transmission rate. There is disclosed a method, for a terminal, for providing information to a network. The method comprises: transmitting a message including the information. The message is transmitted with an indication of the priority of the information. The indication may comprise: an indication that the information is high priority; and/or an indication that the information is related to, or is for, Artificial Intelligence (AI) and/or Machine Learning (ML). The message may be: a Non Access Stratum (NAS) message; a Control Plane Service Request (CPSR) message; and/or an Uplink (UL) NAS Transport message. The information may comprise: a location services message; a 5th Generation Session Management (5GSM) message; a Short Message Service (SMS) message; and/or a Long Term Evolution (LTE) Positioning Protocol (LPP) message.

### TECHNICAL FIELD

Certain examples of the present disclosure provide one or more techniques for prioritising certain data for Artificial Intelligence (AI)/Machine Learning (ML). For example, certain examples of the present disclosure provide one or more techniques for prioritising certain data for AI/ML applications in a 3rd Generation Partnership Project (3GPP) 5th Generation (5G) New Radio (NR) network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The disclosure relates to a method and an apparatus for identifying whether a message associated with AI/ML is high priority or not in a wireless communication system.

### Solution to Problem

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

The present invention is defined in the independent claims. Advantageous features are defined in the dependent claims.

Embodiments or examples disclosed in the description and/or figures falling outside the scope of the claims are to be understood as examples useful for understanding the present invention.

Other aspects, advantages and salient features of the invention will become apparent to those skilled in the art from the following detailed description taken in conjunction with the accompanying drawings.

### Advantageous Effects of Invention

According to an embodiment of the disclosure, it is efficiently identified whether to identify a message associated with AI/ML with high priority in a wireless communication system.

### BRIEF DESCRIPTION OF DRAWINGS

FIG. 1 is a block diagram of an exemplary network entity that may be used in certain examples of the present disclosure,

FIG. 2 illustrates a flowchart for a method performed by a terminal, according to an embodiment, and

FIG. 3 illustrates a flowchart for a method performed by a network entity, according to an embodiment.

### MODE FOR THE INVENTION

The following description of examples of the present disclosure, with reference to the accompanying drawings, is provided to assist in a comprehensive understanding of the present invention, as defined by the claims. The description includes various specific details to assist in that understanding but these are to be regarded as merely exemplary. Accordingly, those of ordinary skill in the art will recognize that various changes and modifications of the examples described herein can be made without departing from the scope of the invention.

The same or similar components may be designated by the same or similar reference numerals, although they may be illustrated in different drawings.

Detailed descriptions of techniques, structures, functions, operations or processes known in the art may be omitted for clarity and conciseness, and to avoid obscuring the subject matter of the present invention.

The terms and words used herein are not limited to the bibliographical or standard meanings, but, are merely used to enable a clear and consistent understanding of the invention.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description and claims of this specification, the singular form, for example “a”, “an” and “the”, encompasses the plural unless the context otherwise requires. For example, reference to “an object” includes reference to one or more of such objects.

Throughout the description and claims of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, example or claim are to be understood to be applicable to any other aspect, embodiment, example or claim described herein unless incompatible therewith.

The skilled person will appreciate that the techniques described herein may be used in any suitable combination.

Herein, the following documents are referenced:
[1] 3 GPP RP-213599
[2] 3GPP TS 24.501 V 18.0.1

3GPP Radio Access Network (RAN) working groups are studying AI/ML and its use in a 3GPP system, for example to enhance mobility, User Equipment (UE) location, amongst other use cases [1].

In some cases, the UE location information is used to make predictions such that the overall location services can be improved.

Currently, the UE sends a location services message to the Location Management Function (LMF) using the Uplink (UL) Non Access Stratum (NAS) TRANSPORT message or the CONTROL PLANE SERVICE REQUEST (CPSR) message (see 3GPP TS 24.501 [2]).

The Access and Mobility Management Function (AMF) determines that the content of the NAS message is location services message based on:
The Payload container type Information Element (IE) indicating “Location services message container”, where this IE may be sent either in the UL NAS TRANSPORT message or the CPSR message.
The Data type field, of the Cellular Internet of Things (CIoT) small data container IE, indicates “Location services message container”. Note that this IE is sent in the CPSR message but not the UL NAS TRANSPORT message.

The AMF determines that the message content is location service message and hence forwards it to the LMF based on the type of data indicated by the UE as described above. In other words, when either the Payload container type IE indicating “Location services message container” is received, or the Data type field, of the CIoT small data container IE, indicates “Location services message container” is received, the AMF forwards the content to the LMF.

As part of the AI/ML study and work in 3 GPP RAN 2 (at least), it is expected that location services message is exchanged between the UE and LMF to be used depending on the use case or objective.

The above information is presented as background information only to assist with an understanding of the present disclosure. No determination has been made, and no assertion is made, as to whether any of the above might be applicable as prior art with regard to the present invention.

Certain examples of the present disclosure provide one or more techniques for prioritising certain data for AI/ML. For example, certain examples of the present disclosure provide one or more techniques for prioritising certain data for AI/ML applications in a 3GPP 5G NR network. However, the skilled person will appreciate that the present invention is not limited to these examples, and may be applied in any suitable system or standard, for example one or more existing and/or future generation wireless communication systems or standards, including any existing or future releases of the same standards specification, for example 3GPP 5G, 5G-advanced or 6^{th} Generation (6G).

The functionality of the various network entities and other features disclosed herein may be applied to corresponding or equivalent entities or features in the same or any other suitable communication systems or standards. Corresponding or equivalent entities or features may be regarded as entities or features that perform the same or similar role, function or purpose within the network. For example:
the functionality of a base station or the like (e.g. eNB, gNB, NB, RAN node, access point, wireless point, transmission/reception point, radio unit, etc.) in the examples below may be applied to any other suitable type of entity performing RAN functions;
the functionality of a UE or the like (e.g. electronic device, user device, mobile station, subscriber station, customer premises equipment, terminal, remote terminal, wireless terminal, vehicle terminal, etc.) in the examples below may be applied to any other suitable type of device;
the functionality of an AMF in the examples below may be applied to any other suitable type of entity performing access and mobility management functions; and/or
the functionality of an LMF in the examples below may be applied to any other suitable type of entity performing location management functions.

A particular network entity may be implemented as a network element on a dedicated hardware, as a software instance running on a dedicated hardware, and/or as a virtualised function instantiated on an appropriate platform, e.g. on a cloud infrastructure.

The skilled person will appreciate that the present invention is not limited to the specific examples disclosed herein. For example:
The techniques disclosed herein are not limited to 3GPP 5G.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements or entities may be added to the examples disclosed herein.
One or more non-essential elements or entities may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed and/or the order in which messages are transmitted may be modified, if possible, in alternative examples.

Certain examples of the present disclosure may be provided in the form of an apparatus/device/network entity configured to perform one or more defined network functions and/or a method therefor. Certain examples of the present disclosure may be provided in the form of a system (e.g. network or wireless communication system) comprising one or more such apparatuses/devices/network entities, and/or a method therefor.

One or more problems exist in the related art, including one or more of the following.

In general, data for AI/ML may need to be sent with high priority depending on the use case and how this information may be used for inference or predictions which may be needed in a prioritised manner or in real-time.

According to the existing mechanisms, as described above with respect to the AMF identifying the type of data, being for example location services message, there is no way for the AMF to know whether a location services message is high priority or not, for example because the data is supposed to be used for AI/ML.

Although this problem is described with reference to location services message, the same issue can also arise with other types of container contents that the UL NAS TRANSPORT message may carry, for example 5G Session Management (5GSM) message, Short Message Service (SMS), Long Term Evolution (LTE) Positioning Protocol (LPP) message container, etc.

To summarise, any of the existing contents that can be sent in the UL NAS TRANSPORT message may be required to be sent in a prioritised manner and there is currently no mechanism for the AMF (or other network entity) to differentiate “regular” vs “prioritised” data of the same kind.

Certain examples of the present disclose provide a method, for a User Equipment (UE), for providing information to a network, the method comprising: transmitting a message including the information, wherein the message is transmitted with an indication of the priority of the information. In certain examples, “with” may be interpreted not only as transmitting in the same message, but also transmitting in different messages (either at the same time or at different times), where the different messages may be associated with each other.

In certain examples, the indication may comprise one or more of: an indication that the information is high priority; and an indication that the information is related to, or is for, Artificial Intelligence (AI) and/or Machine Learning (ML).

In certain examples, the message may be at least one of: a Non Access Stratum (NAS) message; a Control Plane Service Request (CPSR) message; and an Uplink (UL) NAS Transport message.

In certain examples, the information may comprise one or more of: a location services message; a 5th Generation Session Management (5GSM) message; a Short Message Service (SMS) message; and a Long Term Evolution (LTE) Positioning Protocol (LPP) message.

In certain examples: the indication may be included in the message; and/or the indication may be provided separately from the message.

In certain examples, the indication may be provided in an Information Element (IE).

In certain examples, the IE may be one or more of: a Data Type IE; and Payload Container Type IE.

In certain examples, the indication may be provided in a Radio Resource Control (RRC) message.

In certain examples, the message may be transmitted to a first network entity.

In certain examples, the first network entity may be an Access and Mobility Management Function (AMF).

In certain examples, the message may be received by a second network entity.

In certain examples, the second network entity may be one or more of: a Location Management Function (LMF); and a Session Management Function (SMF).

In certain examples, transmitting the message may comprise transmitting the message based on a determination that the UE and/or the network supports the indication.

In certain examples, the method may further comprise receiving a configuration for configuring the UE to support the indication.

In certain examples, the method may further comprise transmitting an indication of support, by the UE, for the indication.

Certain examples of the present disclosure provide a method, for a first network entity, for handling information provided to the network, the method comprising:
receiving a message including the information, wherein the message is received with an indication of the priority of the information; and handling the information with a priority based on the indication.

In certain examples, handling the information may comprise one or more of:
processing the information; and forwarding the information to a second network entity.

Certain examples of the present disclosure provide a User Equipment (UE) configured to perform a method according to any example, aspect, embodiment and/or claim disclosed herein.

Certain examples of the present disclosure provide a first network entity configured to perform a method according to any example, aspect, embodiment and/or claim disclosed herein.

Certain examples of the present disclosure provide a network (or wireless communication system) comprising a UE and a first network entity according to any examples, aspects, embodiments and/or claims disclosed herein.

Certain examples of the present disclosure provide a computer program comprising instructions which, when the program is executed by a computer or processor, cause the computer or processor to carry out a method according to any example, aspect, embodiment and/or claim disclosed herein.

Certain examples of the present disclosure provide a computer or processor-readable data carrier having stored thereon a computer program according to any example, aspect, embodiment and/or claim disclosed herein.

According to certain examples of the present disclosure, the UE may provide an indication of priority when the UE sends contents that are related to AI/ML. In certain examples, the contents may be considered to be high priority by the UE.

The contents may be data related to location services message, 5GSM, SMS, LPP, or any other data or content type that can be transported using the UL NAS TRANSPORT message (or CPSR message). The content type may be a type existing currently or may be a type defined in the future.

In certain examples of the present disclosure, when the AMF (or other suitable network entity) receives any content type (e.g. location services message, 5GSM, SMS, LPP, or any other suitable data type that may be defined and transported using the UL NAS TRANSPORT message or CPSR message) with an indication of the data/content being high priority, the AMF may prioritise that content over other data types that are not high priority.

UE indication of high priority data which is sent in the UL NAS TRANSPORT or CPSR message

In certain examples, the UE should indicate, in a NAS message, or any other suitable type of message, whether the data or message or content being sent in the message (e.g. NAS message) is of high priority or is related to AI/ML. Hereafter, the indication that “data which is related to AI/ML or data for AI/ML” may be considered to mean that the data is of high priority.

In certain examples, the NAS message may be the UL NAS TRANSPORT message or the CPSR message, or any other NAS message which may be used to transport data for AI/ML.

The data, for which the UE indicates to be data which is data for AI/ML, may be contents related to location services message, 5GSM message, SMS, LPP, etc., or any other new or existing data type that may be defined and that may be used for AI/ML. The description below refers to location services message. However, the skilled person will appreciate that this is one example, and that the techniques described herein may be applied to any other suitable data type.

In certain examples, the indication may be in the form of an information element (IE), or any other suitable type of indicator. For example, a new Data type IE may be defined, where this IE may have a new defined value that can be set to “high priority data” or “AI/ML data”, etc. The skilled person will appreciate that the IE and value names given above are examples and that any other suitable names may be used.

In certain examples, the UE may support sending this type of indication by configuration, where the UE may be locally preconfigured to do so or may be configured to send this type of indication by the network using any NAS or Radio Resource Control (RRC) message or any configuration methods. In certain examples, the network may indicate to the UE that the network supports receiving this indication, or may indicate to the UE that the network supports features for AI/ML, where this indication may be sent to the UE using any NAS or RRC message. Once received, the UE may consider this as an implicit indication to report its capability (for sending the proposed high priority indication to the network) or an indication that the network supports the handling of this new indication (of high priority data or of data for AI/ML).

As such, when the UE determines to use or send this indication, for example based on configuration or indication from the network (as described above), or based on the UE sending data that is for AI/ML, then the UE should provide this new indication in the NAS message. The NAS message may be a CPSR message or a Service Request message or UL NAS TRANSPORT message or any NAS message.

In certain examples, the UE may use existing IEs to provide an indication of high priority data or to indicate that the data is for AI/ML. The existing IEs may be IEs that exist in any NAS message, and may contain bit positions which can be used to define a particular value (e.g. value 1) to indicate that the data is for AI/ML.

For example, if the UE is sending location services message for AI/ML, the UE may include this new indication (e.g. the Data type IE or any existing IE, where this IE may indicate high priority data or data for AI/ML) in the NAS message which may be the UL NAS TRANSPORT message or the Service Request message or the CPSR message.

In certain examples, the existing Payload container type IE may be used to define, for example “Location services message for AI/ML”, or “LPP for AI/ML”, “5GSM for AI/ML”, etc. As such, when the UE sends data for AI/ML, the UE may set the value of this IE accordingly to differentiate it from “regular” data of the same kind but which is not for AI/ML, or which may be for AI/ML but not of high priority.

In certain examples, an indication of high priority data may be sent in an RRC message to the RAN entity, where existing IEs and/or new IEs, and/or existing bit(s) and/or a new bit(s) may be defined or used for this purpose. Once received at the RAN, the RAN may then forward this indication to the AMF when also forwarding a NAS message from the UE to the AMF.

To summarise, in certain examples, one or more of the following techniques for the UE may be used:
When the UE sends location services message (or other types of messages or contents as described above) such that the message is for AI/ML, or is for high priority AI/ML, the UE may also send an indication that the location services message is for AI/ML or is high priority (AI/ML) data. The indication may be of any suitable form as described above. The indication may be sent in any suitable message, including NAS message and/or RRC message.
When the UE sends location services message which is not for AI/ML, then the UE need not send a new indication and may simply re-use the existing indications, as described above.

In certain examples, if the UE has location services message that is not for AI/ML which needs to be sent, and also has location services message which is for AI/ML and which also needs to be sent, then the UE should prioritise the transmission of the location services message for AI/ML over the “regular” data which is not for AI/ML or which may be for AI/ML but is not considered high priority.

Network prioritising data for AI/ML based on new received indications

In certain examples, the network should prioritise certain data or contents based on new indications that are received from another entity, where the other entity may be, for example, the UE, or the RAN, or local configurations or policies in the AMF, or based on subscription information obtained from the Unified Data Management (UDM) function.

In certain examples, the AMF may receive the indication of the location services message being for AI/ML or being for high priority using one or more of the following:
A new indication is received in any NAS message, where this indication may be an new IE or an existing IE (as described above). The NAS message may be any NAS message, for example UL NAS TRANSPORT message, Service Request message, CPSR message, or any other suitable type of message.
A new indication is received from the RAN that the NAS message contents, or any other content from the UE, is for AI/ML or is for high priority (AI/ML) data.
The subscription information received from the UDM indicates that, for example, location services message sent by the UE is for AI/ML or is for high priority (AI/ML) data.

In certain examples, when the new indication is received and the AMF receives, for example location services message from the UE, the AMF should prioritise the handling of this message over other message (e.g. of normal or lower priority) from the same UE or different UEs. Therefore the treatment (processing, forwarding, handling, etc) of location services for AI/ML should be prioritised in the AMF.

As indicated above, the location services message is merely an example and the skilled person will appreciate that the techniques described can be applied to other data types, for example as described above. As such, the AMF may also prioritise these messages when they are received with the new indication and may hence forward the message to the destination (e.g. LMF, Session Management Function (SMF), etc.) in a prioritised manner.

Examples of the present disclosure enable a UE or network to identify higher priority data, for example location services message, for AI/ML which would otherwise not be possible. This identification allows for a prioritised treatment at the UE and network side for an improved overall service.

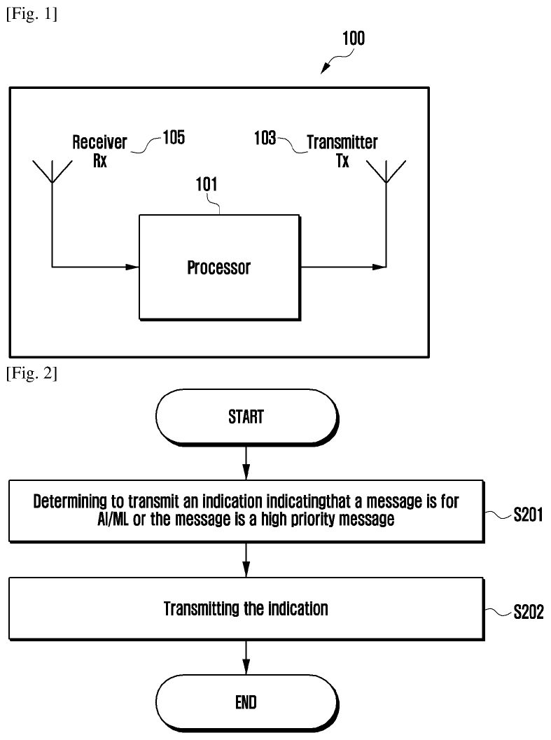

FIG. 1 is a block diagram of an exemplary network entity that may be used in examples of the present disclosure. For example, a UE, a terminal, a base station, an AMF entity, an LMF entity and/or another other suitable network entity may comprise an entity of FIG. 1.

The skilled person will appreciate that a network entity may be implemented, for example, as a network element on a dedicated hardware, as a software instance running on a dedicated hardware, and/or as a virtualised function instantiated on an appropriate platform, e.g. on a cloud infrastructure.

The entity 100 comprises a processor (or controller) 101, a transmitter 103 and a receiver 105. The receiver 105 is configured for receiving one or more messages from one or more other network entities, for example as described above. The transmitter 103 is configured for transmitting one or more messages to one or more other network entities, for example as described above. The processor 101 is configured for performing one or more operations, for example according to the operations as described above.

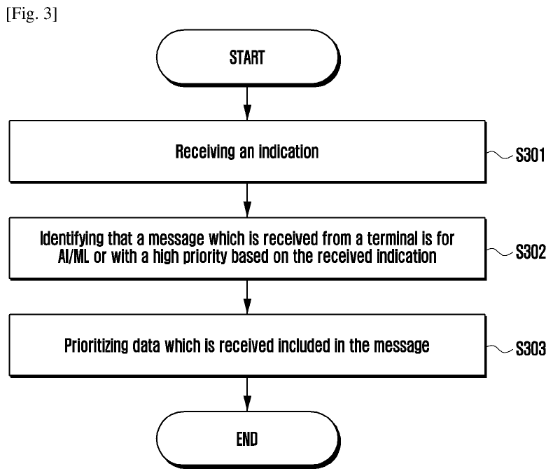

FIG. 2 illustrates a flowchart for a method performed by a terminal, according to an embodiment.

At S201, a terminal may determine to transmit an indication indicating that a message is for AI/ML or the message is a high priority message. In certain examples, the terminal may indicate data included in the message is data with the high priority or data for AI/ML. For example, the message is a location service message.

At S202, the terminal may transmit the indication. The terminal may transmit the indication indicating the high priority or the message for AI/ML. In certain examples, the terminal may transmit the indication using a NAS message or an RRC message. In certain examples, the terminal may transmit the message including the indication or transmit the message and the indication separately.

FIG. 3 illustrates a flowchart for a method performed by a network entity, according to an embodiment. The network entity of FIG. 3 may be one of an AMF entity, an LMF entity, or other network entity.

At 301, the network entity may receive an indication. In certain examples, the network entity may receive an NAS message including the indication from a terminal.

At 302, the network entity may identify that a message which is received from the terminal is for AI/ML or with a high priority based on the received indication. In certain examples, the message is a location service message.

At 303, the network entity may prioritize data which is received included in the message.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

While the invention has been shown and described with reference to certain examples, it will be understood by those skilled in the art that various changes in form and detail may be made therein without departing from the scope of the invention, as defined by the appended claims.

1. A method, for a terminal for providing information to a network, the method comprising:
transmitting a message including the information,
wherein the message is transmitted with an indication of the priority of the information.

2. A method according to claim 1, wherein the indication comprises one or more of:
an indication that the information is high priority; and
an indication that the information is related to, or is for, Artificial Intelligence (AI) and/or Machine Learning (ML).

3. A method according to claim 1, wherein the message is at least one of:
a Non Access Stratum (NAS) message;
a Control Plane Service Request (CPSR) message; and
an Uplink (UL) NAS Transport message.

4. A method according to claim 1, wherein the information comprises one or more of:
a location services message;
a 5th Generation Session Management (5GSM) message;
a Short Message Service (SMS) message; and
a Long Term Evolution (LTE) Positioning Protocol (LPP) message.

5. A method according to claim 1, wherein:
the indication is included in the message; and/or the indication is provided separately from the message.

6. A method according to claim 1, wherein the indication is provided in an Information Element (IE).

7. A method according to claim 6, wherein the IE is one or more of:
a Data Type IE; and
Payload Container Type IE.

8. A method according to claim 1, wherein the indication is provided in a Radio Resource Control (RRC) message.

9. A method according to claim 1, wherein the message is transmitted to a first network entity.

10. A method according to claim 9, wherein the first network entity is an Access and Mobility Management Function (AMF).

11. A method according to claim 9, wherein the message is received by a second network entity.

12. A method according to claim 11 any preceding claim, wherein the second network entity is one or more of:
a Location Management Function (LMF); and
a Session Management Function (SMF).

13. A method according to claim 1, wherein transmitting the message comprises transmitting the message based on a determination that the UE and/or the network supports the indication.

14. A method according to claim 2, further comprising receiving a configuration for configuring the UE to support the indication.

15. A method according to claim 1, further comprising transmitting an indication of support, by the UE, for the indication.
